(19) United States
(12) Patent Application Publication
(10) Pub. No.: US 2006/0236954 A1
(43) Pub. Date: Oct. 26, 2006

(54) Animal restraining apparatus

(76) Inventor: T. Michael Abinanti, Palatine, IL (US)

Correspondence Address: Douglas H. Pauley;Pauley Petersen & Erickson, Suite 365, 2800 West Higgins Road, Hoffman Estates, IL, 60195, US

(21) Appl. No.: 11/388,220

(22) Filed: Mar. 23, 2006

Related U.S. Application Data
(63) Continuation-in-part of application No. 10/902,501, filed on Jul. 29, 2004.

(51) Int. Cl. A01K 27/00

(52) U.S. Cl. 119/792

(57) ABSTRACT

An animal restraining apparatus having a belt positionable about a girth of an animal. A collar is positionable about a neck portion of the animal. A strap connects the belt to the collar. An elastic element is connected with respect to the strap to gather a portion of the strap to form an undulation in the strap. The elastic element is extendable with respect to the strap to remove the undulation. A second elastic element can be connected with respect to the collar to gather a portion of the collar to form an undulation. The second elastic element is extendable with respect to the collar to remove the undulation in the collar. In one embodiment of this invention, a leash guard is removably attachable to the belt and has a guide ring. A leash can be guided through the guide ring and a belt ring mounted on the belt, and attached directly to the collar.

### CROSS REFERENCE TO RELATED APPLICATION

This application is a continuation-in-part of U.S. application Ser. No. 10/902,501, filed on 29 Jul. 2004. The co-pending parent application is hereby incorporated by reference herein in its entirety and is made a part hereof, including but not limited to those portions which specifically appear hereinafter.

### BACKGROUND OF THE INVENTION

1. Field of the Invention

This invention relates to an apparatus for restraining an animal, such as a dog, that can be used in combination with a collar.

2. Discussion of Related Art

Many different conventional collars are used to restrain a dog or other household animal when training and/or exercising the animal. Conventional collars are adjustable, for example with a buckle, with a hook-and-loop strap or any other suitable adjustable fastener. Other conventional collars include a choke chain.

During training or exercise, a leash is attached to the conventional collar. When the leash is pulled, the collar restrains the animal. However, many conventional collars choke or otherwise apply undesirable forces to a neck portion of the animal. It is apparent that there is a need for an animal restraining device that causes less harm and/or irritation to the animal, particularly to the neck area of the animal.

### SUMMARY OF THE INVENTION

It is one object of this invention to provide an animal restraining device that is less harmful to an animal being trained or exercised.

It is another object of this invention to provide an animal restraining device that prevents entanglement of a leash in an animal's leg.

The above and other objects of this invention are accomplished with an animal restraining apparatus including a belt preferably adjustably positionable about a girth of an animal. In one preferred embodiment of this invention, at least a portion of the belt has a width that varies along a length of the belt. A collar is preferably adjustably positionable about a neck portion of the animal and operatively connected to the belt.

A strap connects the belt to the collar. An elastic element is connected with respect to the strap to gather at least a portion of the strap to form a slack portion, a loop or an undulation in the strap. The elastic element is extendable to remove the undulation and increase a peripheral length of the strap. With the elastic element in an extended position, a final or extended length of the strap is greater than an initial or relaxed length of the strap.

In one preferred embodiment of this invention, in a fastened condition of the collar, a peripheral length of the collar is variable. Preferably, an elastic element is connected with respect to the collar to gather at least a portion of the collar to form a slack portion, a loop or an undulation in the collar. The elastic element is extendable to remove the undulation in the collar and increase a peripheral length of the collar. A pad can be removably attached or detachably mounted to an inner surface of the collar, and positionable between the inner surface and a throat area of the animal to protect the throat area during use of the animal restraining apparatus. A leash guard is preferably but not necessarily removably attachable to the belt, and includes a guide ring for guiding a leash through the leash guard for attachment to the belt or the collar.

In one preferred embodiment of this invention, the belt includes a belt ring. In order to prevent the leash from entangling in one or more of the animal's legs, the leash can be guided through the guide ring and connected to the belt, or the leash can be guided through the guide ring and the belt ring and attached directly to the collar using a suitable mechanical connector, such as a clip.

In one preferred embodiment of this invention, the belt of the animal restraining apparatus can be closed so that it forms a void or an opening. A guide element is either connected to the belt or is formed by the belt. A line, such as a rope, a cord, a belt, a band, a chain and/or wire, is moveably mounted with respect to the belt. In one embodiment, the line is slidably mounted within a channel formed between the belt and the guide element.

The guide element maintains a position of the line with respect to the belt. In one embodiment of this invention, opposite free end portions of the line are directed outward from the guide element. A keeper element can be attached with respect to the belt. In one embodiment of this invention, the free end portions are routed through the keeper element.

Preferably but not necessarily, the line is overlapped near the keeper element. When overlapped, the opposite free end portions can be directed away from each other to close the belt and thus reduce the size of the opening. In one embodiment of this invention, the belt can be positioned about a stomach area or other body portion of the animal.

Preferably, one free end portion of the line is connected or attached to the strap connecting the belt to the collar. Alternatively, the free end portion is directed and attached to the collar. The other free end portion is directed away from the strap and/or collar. Preferably but not necessarily, the other free end portion is connected or attached to a leash and the leash is guided through the leash guide ring.

When the leash is pulled and the other free end portion is directed away from the belt, the length of the belt portion which is within the channel between the guide element and the belt decreases and thus reduces the size of the opening. The reduced opening size fits tighter around a stomach area of the animal and thus tightens the belt about the body of the animal.

When the force on the leash is released, the length of the belt portion within the channel increases and thus increases the size of the opening and relieves pressure on the body of the animal.

The animal restraining apparatus of this invention can be used for exercising and/or training a dog or other animal. During either activity, the keeper element can be positioned near a back portion of the body of the animal. In this situation, the leash is directed over the back portion of the body, over the tail portion and away from the animal. Also during either activity the keeper element can be positioned near the bottom stomach portion of the animal. In this situation, the other free end portion is directed between the rear legs of the animal and away from the body of the animal.

The animal restraining apparatus of this invention reduces undesirable forces applied to the neck area of the animal. The animal restraining apparatus of this invention reduces pulling forces applied to a collar. Also, the animal restraining apparatus of this invention prevents the leash from being tangled within the legs of the animal, for example when the animal is running with an unattended leash.

### BRIEF DESCRIPTION OF THE DRAWINGS

The above-described and other features of this invention are discussed in the specification and can be better understood when read in view of the drawings, wherein:

FIG. 1 is a schematic diagram showing an animal restraining apparatus attached to a dog;

FIG. 2 is a schematic diagram showing another embodiment of an animal restraining apparatus attached to a dog;

FIG. 3 is a top view of a portion of a belt, a guide element and opposite free end portions of a line, according to one embodiment of this invention;

FIG. 4 is top view of a portion of a belt, a guide element and opposite free end portions of a line, according to another embodiment of this invention;

FIG. 5 is a perspective view of an animal restraining apparatus, according to one embodiment of this invention;

FIG. 6 is a cross-sectional view of a section of a belt near the keeper element, according to one embodiment of this invention;

FIG. 7A is a perspective view showing an animal restraining apparatus with opposite free end portions of a line in a relaxed condition;

FIG. 7B is a perspective view of an animal restraining apparatus, as shown in FIG. 7A, but with the opposite free end portions of the line directed away from each other, in a taut condition;

FIG. 8 is a perspective view of an animal restraining apparatus, according to another embodiment of this invention;

FIG. 9 is a schematic diagram showing another embodiment of an animal restraining apparatus attached to a dog;

FIG. 10 is a perspective view of a portion of a strap of the animal restraining apparatus shown in FIG. 9;

FIG. 11 is a schematic diagram of a collar, according to one preferred embodiment of this invention;

FIG. 12 is a schematic diagram showing another embodiment of an animal restraining apparatus attached to a dog;

FIG. 13 is a schematic diagram of a collar including an elastic element connected to a first end portion and a second end portion of the collar, according to one preferred embodiment of this invention; and

FIG. 14 is a schematic diagram of a portion of a collar having an elastic element including a first elastic member and a second elastic member each connected to a first end portion and a second end portion of the collar, according to one preferred embodiment of this invention.

### DESCRIPTION OF PREFERRED EMBODIMENTS

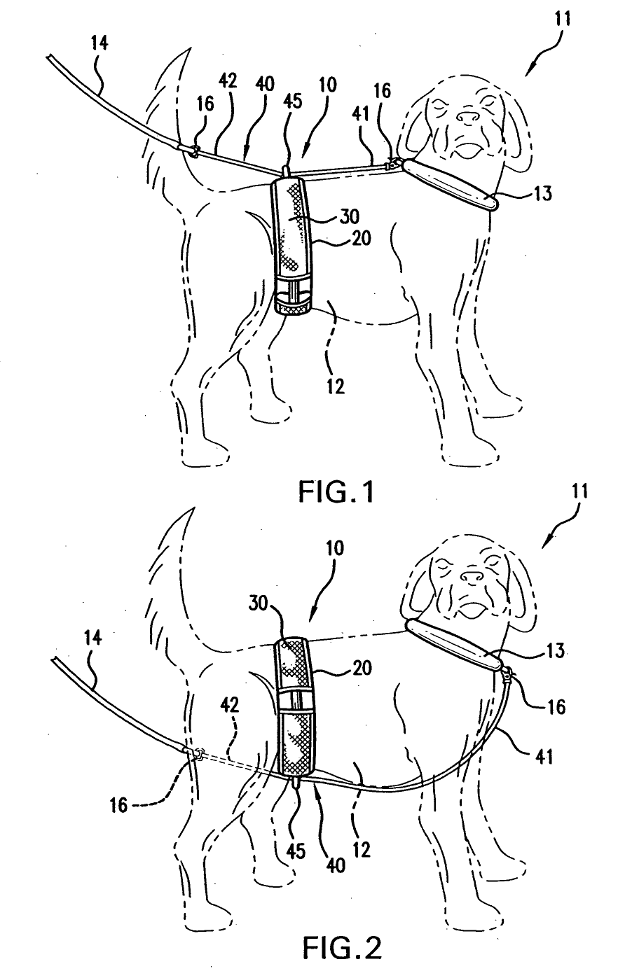

FIGS. 1 and 2 show animal restraining apparatus 10 positioned on animal 11, such as a dog, and acting as a cincture positioned about girth 12 of animal 11.

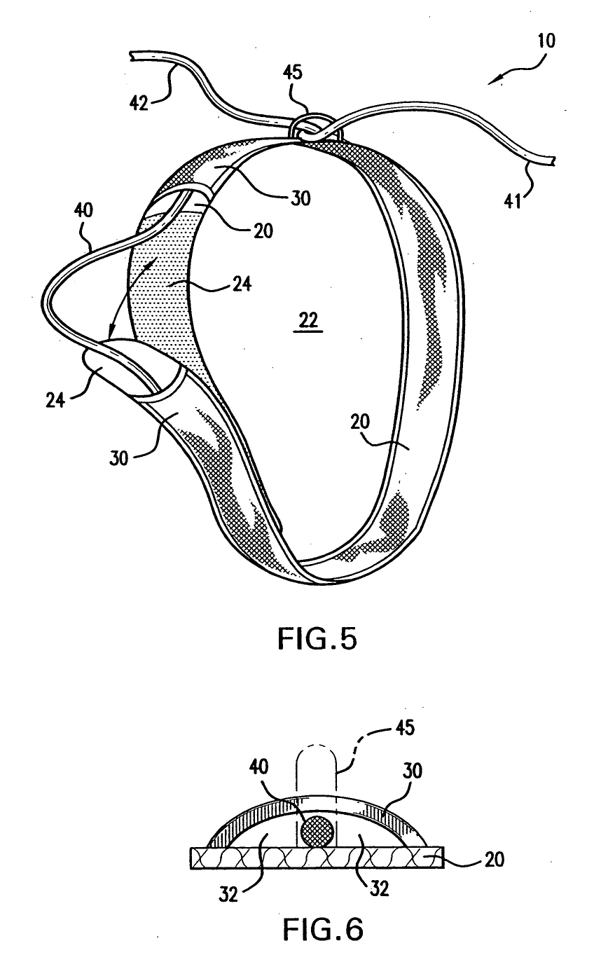

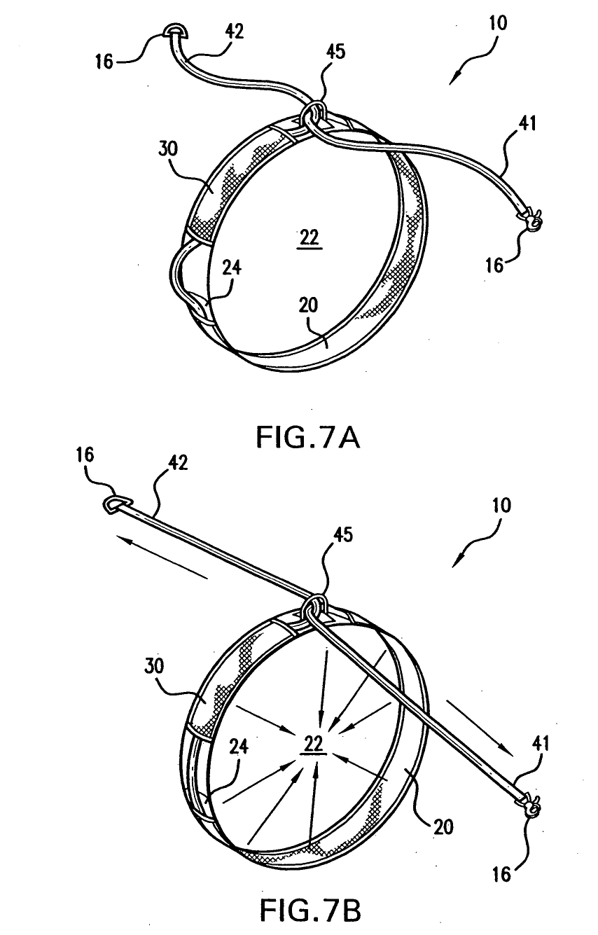

FIGS. 5, 7A, 7B and 8 show belt 20 forming a void or opening 22. FIGS. 1 and 2 show girth 12 of animal 11 positioned within opening 22. Opposing free end portions 41 and 42 of line 40 are pulled in opposite directions to reduce the size of opening 22, such as shown in FIG. 7B. As belt 20 tightens about girth 12 of animal 11, the constricting movement grabs the attention of and thus restrains animal 11.

Belt 20 can be positioned at various suitable locations along the body of animal 11. FIGS. 1 and 2 show one preferred position of belt 20 with respect to animal 11, where belt 20 is slightly forward of the front portion of the two rear legs of animal 11.

FIG. 1 shows belt 20 positioned so that keeper element 45 points upward. In this position, free end portion 42 of line 40 and/or leash 14 is routed over the back portion of animal 11, preferably but not necessarily over the tail portion of animal 11, as shown in FIG. 1.

FIG. 2 shows keeper element 45 positioned downward, so that keeper element 45 is near the stomach portion of animal 11. In such position, free end portion 42 of line 40 is routed rearward between the rear legs of animal 11.

Regardless of the position of belt 20 with respect to the back portion and/or the stomach portion of animal 11, keeper element 45 acts as a guide for directing free end portion 42 and/or free end portion 41 of line 40. The guiding function of keeper element 45 helps maintain the general position of leash 14 and/or end portion 42. Because belt 20 and thus keeper element 45 is maintained at a rearward portion of animal 11, regardless of the direction in which a forward portion of animal 11 moves, leash 14 and/or end portion 42, with keeper element 45, maintains a general position of leash 14 and/or free end portion 42 routed over the back portion or the stomach portion of animal 11.

As shown in FIGS. 1 and 2, free end portion 41 of line 40 is attached, such as detachably attached, or connected to collar 13. As shown in FIG. 1, the attachment to collar 13 is near a rear neck portion of animal 11. As shown in FIG. 2, free end portion 41 of line 40 is connected or attached to collar 13 which is in a downward position on the neck of animal 11.

During use, when leash 14 is pulled away from animal 11, free end portion 42 of line 40 moves in an opposite direction with respect to free end portion 41 of line 40. During such movement, belt 20 constricts and thus reduces the area of opening 22. Such movement restrains animal 11. When the force pulling leash 14 is released or reduced, free end portions 41 and 42 move towards each other and increase the peripheral length of belt 20. This movement eases the forces acting to restrain animal 11.

In another embodiment of this invention, free end portion 41, such as shown in FIG. 1, can be directly connected or attached with respect to belt 20. For example, as shown in FIG. 1, the rearward portion of free end portion 41 can be connected to or attached to belt 20, guide element 30 and/or keeper element 45. Free end portion 41 can be connected to or attached to a fastener that can be fixedly or detachably connected to belt 20, guide element 30 and/or keeper element 45. In such embodiment, fee end portion 41 has a fixed length which can be designed to limit the travel distance that belt 20 moves away from or with respect to collar 13. In use, a significant portion of the pulling force exerted by leash 14 is directed to belt 20 and a significant portion of the pulling force is not directed to collar 13. Thus, in such embodiment, collar 13 acts as a device that maintains the position of belt 20 with respect to the body of animal 11. In such embodiment where free end portion 41 acts as a fixed link, one end of free end portion 41 can be attached to any suitable location about belt 20 and/or guide element 30.

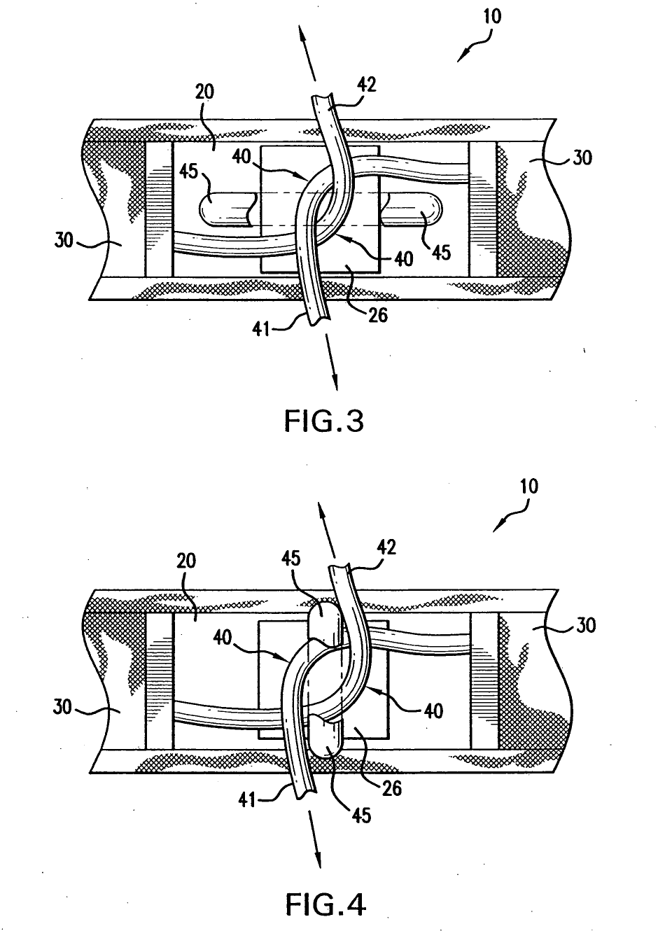

Guide element 30 can be connected to or integrally formed with or by belt 20. Any suitable sewn, adhesive or other suitable connection can be used to secure guide element 30 with respect to belt 20. As shown in FIGS. 3-5, for example, guide element 30 comprises pieces of fabric sewn or otherwise attached to belt 20. FIG. 6 shows channel 32 formed between belt 20 and guide element 30. FIG. 6 also shows line 40 fitting relatively loosely within channel 32. A relatively loose fit within channel 32 allows line 40 to move or slide easily with respect to belt 20.

As shown in the drawings, line 40 is of a rope or cord. However, in other embodiments, line 40 may also be a band, a chain, a wire or any other suitable elongated member that can be routed within channel 32 and connected to collar 13 and/or leash 14. Different materials can be used to construct line 40, which may depend upon a desired coefficient of friction between line 40 and belt 20 and/or guide element 30.

Guide element 30 preferably maintains a position of line 40 with respect to belt 20. Belt 20 is preferably used to comfort animal 11 when animal restraining apparatus 10 is operated according to this invention.

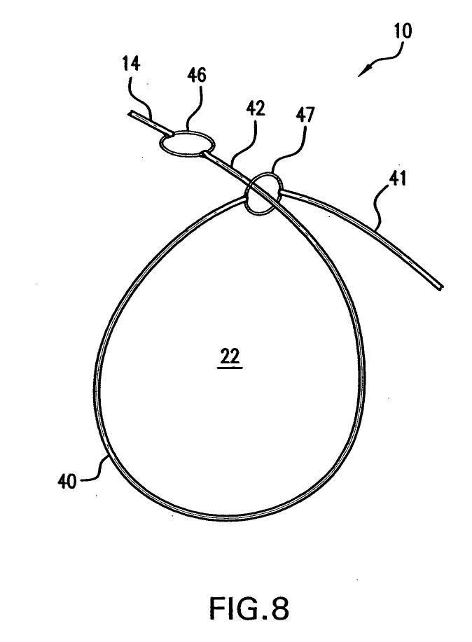

In one other embodiment of this invention, belt 20 and guide element 30 can be replaced by a conventional choke chain having line 40 as a chain or other flexible member positioned between two rings 46 and 47. Free end portions 41 and 42 of line 40 can be attached, one to each of the two rings 46 and 47 of the choke chain. FIG. 8 shows how a conventional choke chain can be attached with respect to leash 14 and/or free end portion 41, particularly to act in combination with collar 13. FIG. 8 shows free end portion 41 attached directly to ring 47, but free end portion 41 can also be routed through ring 47. However, this particular embodiment may cause more discomfort to animal 11 when animal restraining apparatus 10 is operated.

As shown in FIGS. 3 and 4, keeper element 45 can be attached with respect to belt 20, in different directions. Although keeper element 45 is shown in FIGS. 3 and 4 as being attached with respect to belt 20 by sewing or otherwise attaching patch 26 to belt 20, any other suitable connection can be used. Keeper element 45 can be a ring, as shown in the drawings, or can be any other suitable mechanical structure that allows free end portions 41 and 42 to be routed through keeper element 45 and also to be overlapped with respect to each other.

FIGS. 3 and 4 show free end portions 41 and 42 directed outward of guide element 30 and then overlapped with each other near keeper element 45. In this particular embodiment, the opening and closing action of belt 20 and thus the increasing and decreasing, respectively, size of opening 22 occurs easier and with reduced twisting of animal restraining apparatus 10 with respect to animal 11. When free end portions 41 and 42 are not overlapped with respect to each other, belt 20 tends to twist with respect to girth 12 of animal 11.

As shown in FIG. 5, belt 20 forms a loop. FIG. 5 also shows hook-and-loop fastener 24, such as a VELCRO™ hook and loop fastener component, used to releaseably attach one end portion of belt 20 with respect to another end portion of belt 20. With animal restraining apparatus 10 in a condition as shown in FIG. 5, belt 20 along with line 40 can be slipped over two legs, either front or back, of a four-legged animal. Once animal restraining apparatus 10 is mounted, such as a cincture, on animal 11, hook-and-loop fastener 24 or another suitable fastener can be used to adjustably tighten belt 20 about girth 12 of animal 11. In other embodiments of this invention, any other suitable end fastening or connecting device can be used to adjustably secure opposing end portions of belt 20 with respect to each other. Also, it is possible to use an elastic belt 20 in combination with or in lieu of belt 20 and/or guide element 30.

As animal restraining apparatus 10 is operated by directing free end portions 41 and 42 apart from each other, a peripheral length of belt 20 can be varied, such as reduced.

FIGS. 7A and 7B show that guide element 30 can be intermittently positioned along a periphery of belt 20. As shown in FIG. 5, guide element 30 can also be continuously positioned along the periphery of belt 20.

As shown in FIGS. 1, 2, 7A and 7B, free end portion 41 and/or free end portion 42 can be connected or attached to connector 16. Connector 16 can be a clasp, a ring or any other suitable connecting device. As shown in FIGS. 1 and 2, end portion 41 is connected with respect to collar 13.

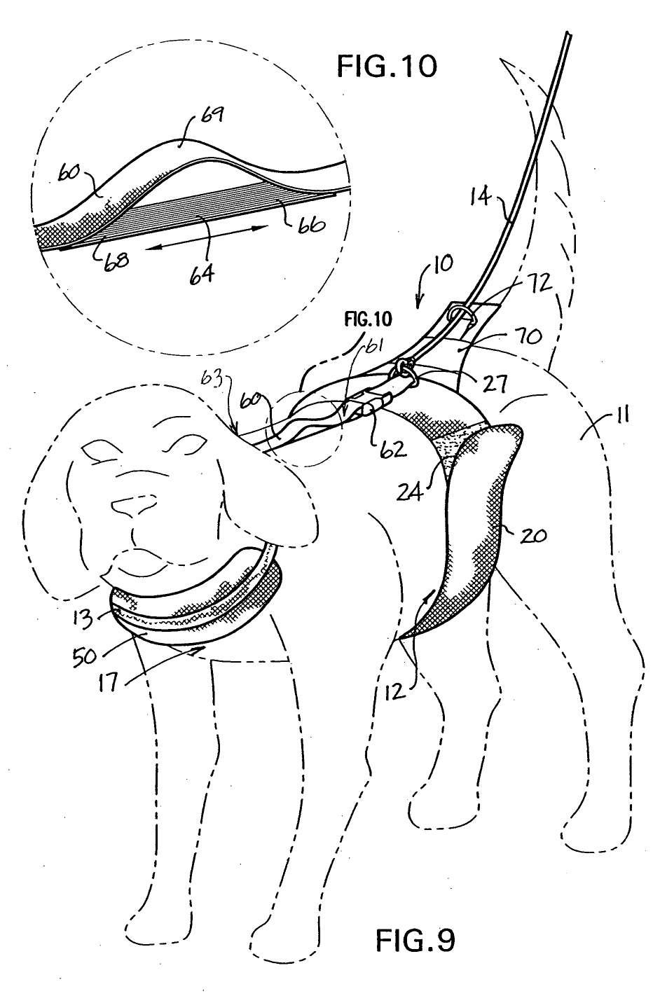

As shown in FIG. 9, in one preferred embodiment of this invention, animal restraining apparatus 10 includes belt 20 positionable about girth 12 of animal 11 and collar 13 positionable about a neck portion 17 of animal 11. Collar 13 is operatively connected to belt 20. Preferably, belt 20 is adjustably positionable about girth 12 using suitable connector or fastener components, such as snaps or a hook-and-loop fastener component 24, for example a VELCRO™ hook and loop fastener component, as shown in FIG. 9. Because belt 20 is adjustable about girth 12 of animal 11, animal restraining apparatus 10 can be used with an animal having any girth size by adjusting a peripheral length of belt 20 to properly fit belt 20 about girth 12. In one preferred embodiment of this invention, at least a portion of belt 20 has a width that varies along the length of belt 20 so that belt 20 can be adjusted to fit about girth 12 of animal 11. For example, a width of belt 20 can narrow at a portion of belt 20 that corresponds with an anterior portion of animal 11 to compensate for the anatomical differences between male dogs and female dogs, for example.

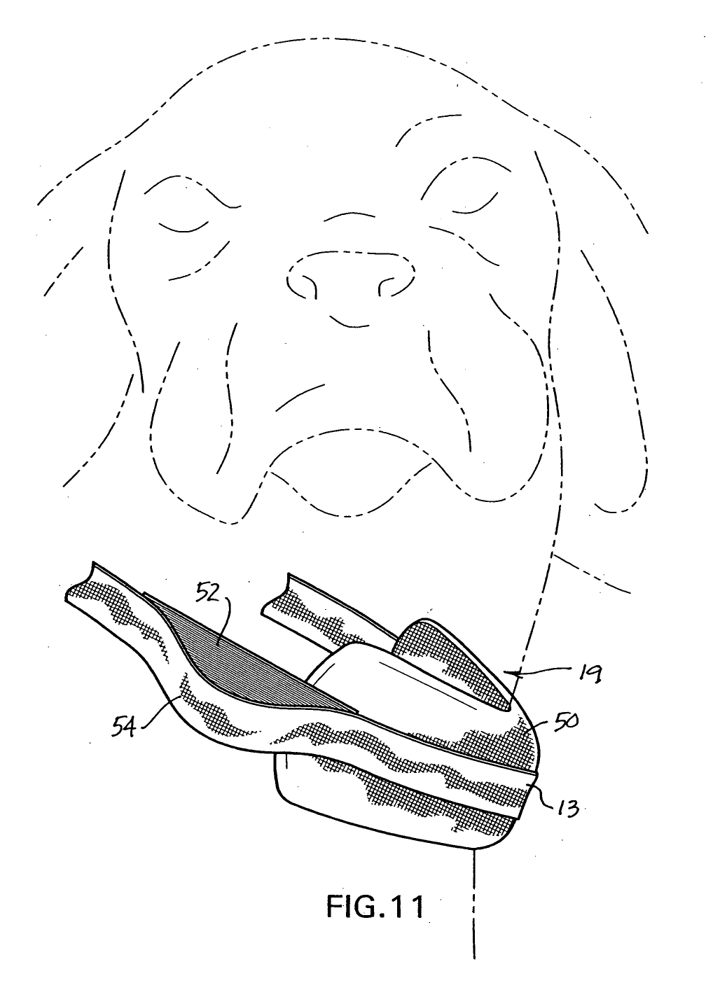

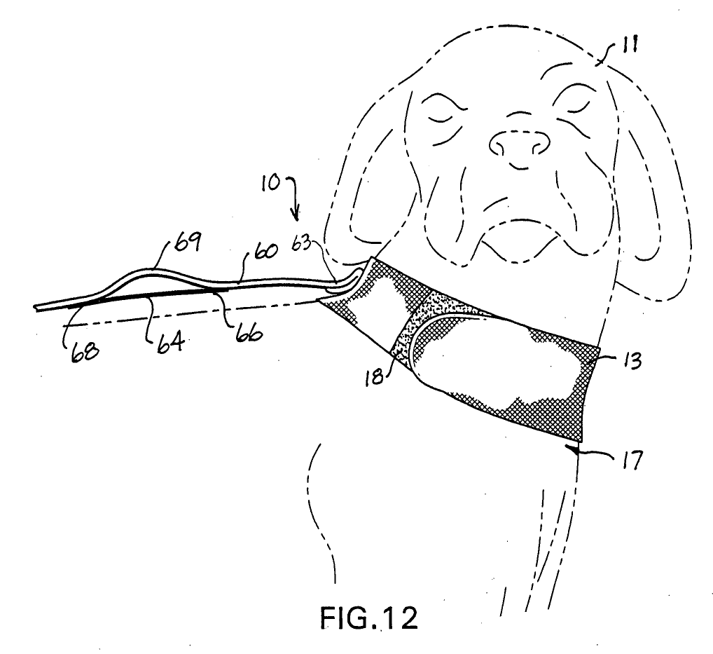

Preferably, collar 13 is adjustably positionable about neck portion 17 using suitable connector or fastener components, such as snaps or a hook-and-loop fastener component 18, for example a VELCRO™ hook and loop fastener component, as shown in FIG. 12. Because collar 13 is adjustable about neck portion 17, animal restraining apparatus 10 can be used with an animal having any neck size by adjusting a peripheral length of collar 13 to properly fit collar 13 about neck portion 17. In one preferred embodiment of this invention, a pad 50 is removably attachable or detachably mountable to an inner surface of collar 13 and preferably positioned between the inner surface of collar 13 and a throat area 19 of animal 11, as shown in FIG. 11. Pad 50 can be attached or fastened to collar 13 using any suitable connector or fastener components, such a hook-and-loop fastener component, for example a VELCRO™ hook and loop fastener component. Alternatively, pad 50 can be integrated with collar 13. Preferably, pad 50 is made of a soft and resilient material that conforms to a surface of throat area 19 to minimize or ease the force or stress acting on throat area 19 during use of animal restraining apparatus 10, for example to restrain animal 11.

Preferably, with collar 13 in a fastened condition, a peripheral length of collar 13 is variable. Referring to FIG. 11, in one preferred embodiment of this invention, collar 13 includes an elastic element 52 connected with respect to collar 13 and gathering at least a portion of collar 13 to form a loop or undulation 54 in collar 13. Elastic element 52 is preferably stretchable or extendable with respect to collar 13 in a direction generally parallel with the length of collar 13 to remove the gathering of collar 13 or undulation 54.

For example, when a force is applied to leash 14 to restrain animal 11, the force is transferred through animal restraining apparatus 10 to collar 13, causing elastic element 52 to extend and move relative to or towards collar 13 to remove the gathering or slack from collar 13. In order to minimize unnecessary forces applied to neck portion 17 of animal 11, elastic element 52 stretches or extends to an extended position to temporarily increase a peripheral length of collar 13 so that collar 13 does not tighten against neck portion 17. Thus, with elastic element 52 in the extended position, collar 13 has a final peripheral length greater than an initial peripheral length. When the force applied to animal restraining apparatus 10 to restrain animal 11 is removed, elastic element 52 returns to an initial or relaxed position to gather at least a portion of collar 13 to form undulation 54.

As shown in FIG. 9, in one preferred embodiment of this invention a strap 60 connects belt 20 to collar 13. Preferably, strap 60 connects belt 20 to collar 13 along a posterior or back portion of animal 11. Alternatively, in certain embodiments of this invention, strap 60 may be positioned along an anterior or stomach portion of animal 11 to connect belt 20 to collar 13. Strap 60 can be connected to belt 20 and/or collar 13 using any suitable mechanical connector. In one preferred embodiment of this invention, a first end portion 61 of strap 60 is connected or attached to belt 20 using a buckle component 62. A second end portion 63 of strap 60 can be connected or attached to collar 13 using a similar buckle component. Alternatively, first end portion 61 can be permanently connected to belt 20 and second end portion 63 can be connected to collar 13 using a clip or other suitable mechanical connector. It is apparent to those skilled in the art that any suitable connector can be used to connect or attach strap 60 to belt 20 and/or collar 13. Preferably, buckle component 62 allows strap 60 to be adjustable to vary an initial length of strap 60 to properly fit animal 11, depending upon the size and/or length of the posterior or back portion of animal 11.

Strap 60 preferably includes an elastic element 64 connected with respect to strap 60. As shown in FIGS. 9 and 10, elastic element 64 is connected at a first end portion 66 and a second end portion 68 to an inner surface of strap 60 to gather at least a portion of strap 60 to form a loop or undulation 69 in strap 60. Elastic element 64 is stretchable or extendable with respect to strap 60 in a direction generally parallel with the length of strap 60 to remove the gathering or slack of strap 60 or undulation 69. For example, when a force is applied to leash 14 to restrain animal 11, the force is transferred through animal restraining apparatus 10 to collar 13. In order to minimize unnecessary forces applied to neck portion 17 of animal 11 and prevent or minimize undesirable movement of belt 20 with respect to animal 11, elastic element 64 stretches or extends to an extended position to temporarily increase a length of strap 60. Thus, with elastic element 64 in the extended position, strap 60 has a final or extended length greater than an initial or relaxed length. When the force applied to animal restraining apparatus 10 to restrain animal 11 is removed, elastic element 64 returns to the initial or relaxed position to gather at least a portion of strap 60 to form undulation 69. Animal restraining apparatus 10 according to preferred embodiments of this invention can include elastic element 64 connected with respect to strap 60 and/or elastic element 52 connected with respect to collar 13.

In one preferred embodiment of this invention, animal restraining apparatus 10 includes a leash guard 70 positionable with respect to belt 20. Preferably, leash guard 70 includes a suitable fastener component, such as a hook-and-loop fastener component, for example a VELCRO™ hook and loop fastener component, for removably attaching or fastening leash guard 70 to belt 20, as shown in FIG. 9. Leash guard 70 includes a guide ring 72 for guiding leash 14 through leash guard 70. Leash 14 is then attachable or connectable to belt ring 27 or keeper element 45. Alternatively, leash 14 is guidable through guide ring 72 and belt ring 27 and attachable directly to collar 13 using a suitable mechanical connector, such as a clip. In certain embodiments of this invention, leash 14 can be attached or connected to free end portion 42 of line 40, as discussed below. Leash guard 70 prevents leash 14 from interfering with or undesirably contacting a leg and/or tail of animal 11.

In one preferred embodiment of this invention, with belt 20 of animal restraint apparatus 10 as shown in FIGS. 9-12 in a fastened condition, a peripheral length of belt 20 is variable. Animal restraining apparatus 10 as shown in FIGS. 9-12 can include guide element 30 connected with respect to belt 20. Referring to FIGS. 5 and 6, guide element 30 forms channel 32 between belt 20 and guide element 30. Line 40 is movably mounted within channel 32 and guide element 30 maintains a position of line 40 with respect to belt 20. Opposite free end portions 41 and 42 of line 40 are directed outward from guide element 30 and routed through keeper element 45. Line 40 preferably overlaps itself near keeper element 45, as shown in FIGS. 3 and 4.

Preferably in this embodiment, first free end portion 41 is operatively connected to strap 60 and second free end portion 42 is operatively connected to leash 14. For example, leash 14 can be guided through guide ring 72 of leash guard 70 and attached or connected to second free end portion 42 of line 40. In certain embodiments of this invention, first free end portion 41 can be directly connected to collar 13.

During use, when leash 14 is pulled away from animal 11, free end portion 42 of line 40 moves in an opposite direction with respect to free end portion 41 of line 40. During such movement, belt 20 constricts and thus reduces the area of opening 22. Such movement restrains animal 11. Additionally, the length of strap 60 is increased by the extension of elastic element 64 to reduce the forces applied to the neck portion of animal 11 as a result of the movement of leash 14 with respect to animal 11. When the force pulling leash 14 is released or reduced, free end portions 41 and 42 move towards each other and increase the peripheral length of belt 20. This movement eases the forces acting to restrain animal 11. Further, elastic element 64 is urged to its initial or relaxed position, wherein a portion of strap 60 is gathered to form undulation 69.

In one preferred embodiment of this invention, animal restraining apparatus 10 further includes elastic element 52 connected with respect to collar 13 to form undulation 54 in collar 13. In response to the movement of leash 14 with respect to animal 11, the peripheral length of collar 13 is increased by the extension of elastic element 52 to reduce the forces applied to the neck portion of animal 11 as a result of the movement of leash 14 with respect to animal 11. When the force pulling leash 14 is released or reduced, elastic element 52 is urged to its initial or relaxed position, wherein a portion of collar 13 is gathered to form undulation 54.

In one preferred embodiment of this invention, animal restraining apparatus 10 includes at least one extendable component, such as belt 20, collar 13 and/or strap 60. The extendable component can be made of any suitable material, such as leather, rope, nylon and/or any suitable natural or synthetic material. An elastic element is connected with respect to the extendable component and gathers a portion of the extendable component to form at least one undulation in the extendable component. The elastic element is extendable to reduce and/or remove the undulation. With the elastic element in an extended position, a final length of the extendable component is greater than an initial length of the extendable component. In one preferred embodiment of this invention, the extendable component itself is made of a stretchable or elastic material. Alternatively, the extendable component may be made of a nonstretchable or inelastic material that is extendable as a result of each undulation formed in the extendable component.

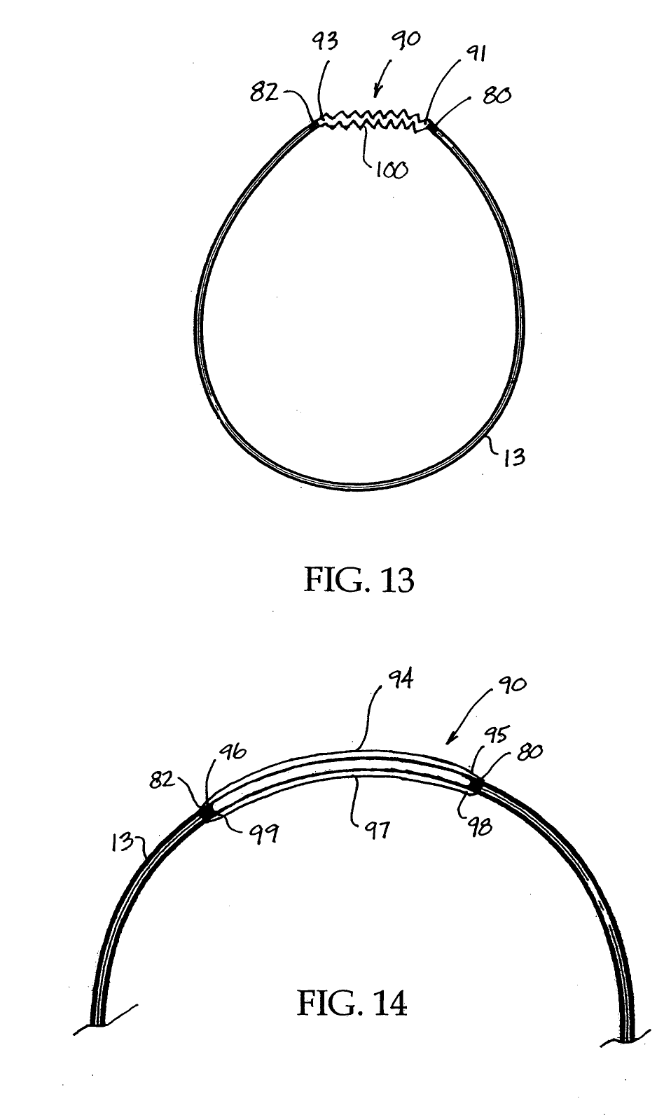

As shown in FIG. 13, in one preferred embodiment of this invention, collar 13 has a first end portion 80 and a second end portion 82. An elastic element 90 is connected or attached to at a first end portion 91 to first end portion 80 of collar 13. Similarly, a second end portion 93 of elastic element 90 is connected or attached with respect to second end portion 82 of collar 13. Elastic element 90 is preferably stretchable or extendable in a direction generally parallel with the length of collar 13, for example to increase the peripheral length of collar 13 when a force is applied to animal restraining apparatus 10 to restrain animal 11. Thus, with elastic element 90 in the extended position, collar 13 has a final peripheral length greater than an initial peripheral length in an initial or relaxed position. When the force applied to animal restraining apparatus 10 to restrain animal 11 is removed, elastic element 90 returns toward or to the relaxed position. In the relaxed position, elastic element 90 preferably is gathered to form at least one relaxed portion 100, such as a slack portion, a loop and/or an undulation, as shown in FIG. 13. Elastic element 90 can be made of any suitable material having elastic properties, such as a suitable polymeric material.

In one preferred embodiment of this invention, as shown in FIG. 14, elastic element 90 includes a first elastic member 94. First elastic member 94 is attached or connected at a first end portion 95 to first end portion 80 of collar 13. Similarly, a second end portion 96 of first elastic member 94 is attached or connected to second end portion 82 of collar 13. Elastic element 90 also preferably includes a second elastic member 97 generally parallel with the first elastic member 94. In one preferred embodiment of this invention, first elastic member 94 has an elastic tension different than an elastic tension of second elastic member 97. A first end portion 98 of second elastic member 97 is attached or connected to first end portion 80 of collar 13 and a second end portion 99 of second elastic member 97 is attached or connected to second end portion 82 of collar 13.

The different elements of this invention can be made from the same or different suitable materials, depending upon the desired strength and/or style of animal restraining apparatus 10.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. In an animal restraining apparatus, the improvement comprising:
a strap positionable with respect to a body of an animal; and
an elastic element connected with respect to the strap and gathering a portion of the strap to form an undulation in the strap, and the elastic element extendable to remove the undulation.

2. The animal restraining apparatus according to claim 1 wherein the strap is adjustable to vary an initial length of the strap.

3. The animal restraining apparatus according to claim 1 wherein with the elastic element in an extended position, an extended length of the strap is greater than an initial length of the strap.

4. The animal restraining apparatus according to claim 1 further comprising:
a belt positionable about a girth of the animal; and
a collar positionable about a neck portion of the animal, and the strap connecting the belt to the collar.

5. The animal restraining apparatus according to claim 4 wherein at least a portion of the belt has a width that varies along a length of the belt.

6. The animal restraining apparatus according to claim 4 further comprising a second elastic element connected with respect to the collar and gathering the collar to form an undulation in the collar, and the second elastic element extendable to remove the undulation in the collar.

7. The animal restraining apparatus according to claim 4 further comprising a leash guard removably attachable to the belt and having a guide ring, and a leash guidable through the guide ring and attachable to the belt.

8. The animal restraining apparatus according to claim 4 further comprising:
a guide element connected with respect to the belt and forming a channel between the belt and the guide element;
a line movably mounted within the channel, the guide element maintaining a position of the line with respect to the belt; and
a keeper element, opposite free end portions of the line directed outward from the guide element and routed through the keeper element, the line overlapping itself near the keeper element, and a first free end portion of the opposing free end portions connected to the strap.

9. An animal restraining apparatus comprising:
an extendable component positionable with respect to a body of an animal; and
an elastic element connected with respect to the extendable component and gathering a portion of the extendable component to form an undulation in the extendable component, and the elastic element extendable with respect to the extendable component to remove the undulation.

10. The animal restraining apparatus according to claim 9 wherein with the elastic element in an extended position, an extended peripheral length of the extendable component is greater than an initial peripheral length of the extendable component.

11. The animal restraining apparatus according to claim 9 wherein the extendable component is adjustably positionable about a neck portion of the animal.

12. The animal restraining apparatus according to claim 11 further comprising a pad removably attachable to an inner surface of the extendable component, the pad positionable between the inner surface and a throat area of the animal.

13. The animal restraining apparatus according to claim 9 wherein the extendable component comprises a collar positionable about a neck portion of the animal, the animal restraining apparatus further comprising:
a belt positionable about a girth of the animal;
a strap connected between the belt and the collar; and
a second elastic element connected with respect to the strap and gathering a portion of the strap to form an undulation in the strap, and the second elastic element extendable with respect to the strap to remove the undulation.

14. The animal restraining apparatus according to claim 13 wherein with the second elastic element in an extended position, a length of the strap is increased from an initial length.

15. The animal restraining apparatus according to claim 9 further comprising a belt adjustably positionable about a girth of the animal.

16. The animal restraining apparatus according to claim 15 further comprising:
a guide element connected with respect to the belt and forming a void between the belt and the guide element;
a line movably mounted within the void, the guide element maintaining a position of the line with respect to the belt; and
a keeper element, opposite free end portions of the line directed outward from the guide element and routed through the keeper element, and the line overlapping itself near the keeper element, a first free end portion of the opposing free end portions connected to the extendable component.

17. An animal restraining apparatus comprising:
a belt forming an opening;
a guide element one of connected to the belt and formed by the belt;
a line movably mounted with respect to the belt, the guide element maintaining a position of the line with respect to the belt;
a keeper element connected to the belt, opposite free end portions of the line directed outward from the guide element and routed through the keeper element;
a collar positioned about a neck portion of an animal;
a strap connecting the belt to the collar, a first free end portion of the opposite free end portions of the line connected to the strap; and
an elastic element connected with respect to the strap and gathering a portion of the strap to form an undulation in the strap, and the elastic element extendable with respect to the strap to remove the undulation.

18. The animal restraining apparatus according to claim 17 wherein in a fastened condition of the belt, a peripheral length of the belt is variable.

19. The animal restraining apparatus according to claim 17 wherein in a fastened condition of the collar, a peripheral length of the collar is variable.

20. The animal restraining apparatus according to claim 17 further comprising a leash guard removably attachable to the belt and having a guide ring for guiding a leash through the leash guard, and the leash attachable to a second free end portion of the opposite free end portion of the line.

21. An animal restraining apparatus comprising:
a belt positionable about a girth of an animal;
a collar positionable about a neck portion of the animal and operatively connected to the belt;
a pad detachably mountable to an inner surface of the collar and positionable between the inner surface and a throat area of the animal; and
an elastic element connected with respect to the collar and gathering a portion of the collar to form an undulation in the collar, and the elastic element extendable with respect to the collar to remove the undulation.

22. An animal restraining apparatus comprising:
a belt positionable about a girth of an animal, the belt having a belt ring;
a leash guard removably attachable to the belt, the leash guard having a guide ring; and
a collar positionable about a neck portion of the animal, and a leash guidable through the guide ring and the belt ring and attachable to the collar.

23. The animal restraining apparatus of claim 22 further comprising an elastic element connected with respect to the collar and gathering a portion of the collar to form an undulation in the collar, and the elastic element extendable with respect to the collar to remove the undulation.

24. An animal restraining apparatus comprising:
a collar having a first end portion and a second end portion; and
an elastic element connected at a first end portion with respect to the first end portion of the collar and at a second end portion with respect to the second end portion of the collar, and the elastic element stretchable in a direction generally parallel with a peripheral length of the collar to increase the peripheral length of the collar.

25. The animal restraining apparatus of claim 24 wherein the elastic element includes a first elastic member having a first end portion connected to the first end portion of the collar and a second end portion connected to the second end portion of the collar, and a second elastic member having a first end portion connected to the first end portion of the collar and a second end portion connected to the second end portion of the collar.

26. The animal restraining apparatus of claim 25 wherein the first elastic member has an elastic tension different than an elastic tension of the second elastic member.
